(19) United States
(12) Patent Application Publication
(10) Pub. No.: US 2020/0320552 A1
(43) Pub. Date: Oct. 8, 2020

(54) SALES ANALYSIS APPARATUS, SALES MANAGEMENT SYSTEM, SALES ANALYSIS METHOD, AND PROGRAM RECORDING MEDIUM

(71) Applicant: NEC Platforms, Ltd., Kawasaki-shi, Kanagawa (JP)

(72) Inventor: Hiroki RACHI, Kawasaki-shi, Kanagawa (JP)

(73) Assignee: NEC Platforms, Ltd., Kawasaki-shi, Kanagawa (JP)

(21) Appl. No.: 16/955,841

(22) PCT Filed: Dec. 12, 2018
(86) PCT No.: PCT/JP2018/045599

§ 371 Date: Jun. 19, 2020

(30) Foreign Application Priority Data
Dec. 20, 2017 (JP) 2017-243548

(51) Int. Cl. G06Q 30/02; G06K 9/00; G06Q 10/06; G06Q 20/20

(52) U.S. Cl. CPC G06Q 30/0201; G06Q 20/202; G06Q 10/0637; G06K 9/00771

(57) ABSTRACT

A sales analysis apparatus is provided with: a stay detection unit configured to detect, based on an image obtained by photographing an inside of a shop, a stay location at which a person in the shop has stayed; and an extraction unit configured to extract, a product corresponding to the stay location included in a region excluding a checkout line region being a region occupied by a person waiting for payment in the shop. The sales analysis apparatus is configured to detect, when the extracted product is not purchased, a sales opportunity loss of the unpurchased product determine, when the extracted product is not purchased, that a sales opportunity loss of the unpurchased product has occurred by referring to sales history data indicating a sales history of a product.

### TECHNICAL FIELD

This invention relates to a sales analysis apparatus, a sales management system, a sales analysis method, and a program recording medium.

### BACKGROUND ART

In general, in retail shops, arrangement of products is appropriately designed by using POS (Point-Of-Sales) data so as to sell more products. For example, it is possible to discriminate between a hot-selling product, which is a product belonging to a high-selling product type, and a poor-selling product, which is a product belonging to a low-selling product type, based on the number of sales for each product type obtained from the POS data. Then, it is possible to change the arrangement of products based on the result of discrimination by, for example, replacing a product arranged in a space of poor-selling products with a hot-selling product or other products.

It is desired to obtain data on a sales opportunity loss of a product in order to consider in detail arrangement of products, for example, how to replace products to increase the amount of sales of the product.

For example, in Patent Document 1, there is disclosed a sales opportunity loss analysis data output system for obtaining information on determination of, for example, a balance between a product stock and a sales opportunity loss.

The system described in Patent Document 1 executes processing of analyzing a moving image of an analysis target photographed by a camera, to thereby obtain information on a person in a frame region corresponding to a photography range, such as a position, attribute, stay period, or movement line of that person. The system described in Patent Document 1 uses this information to execute processing of calculating, for each unit within the frame region, statistics of entry by persons including the number of entries by the persons. Then, the system described in Patent Document 1 outputs analysis information containing the entry statistics for each unit associated with a product arranged in a shop, as data for analysis of the sales opportunity loss of the product in the shop.

In the system described in Patent Document 1, an entry statistic calculation unit determines, for example, entry/exit or stay of a person for each unit section indicated by a boundary line, and counts, for example, the number of entries (d). This counting processing uses information (e.g., coordinate information) on a movement line of a person, which is obtained based on analysis or detection of that person in a frame region of a photography range.

### PRIOR ART DOCUMENT(S)

### Patent Document(s)

Patent Document 1: JP 2015-133131 A

### SUMMARY OF THE INVENTION

### Problem to be Solved by the Invention

As described above, the system described in Patent Document 1 counts, as the number of entries, a person who has entered/exited or stayed in a unit section. Thus, a person who stays in a checkout line is not considered in the number of entries described in Patent Document 1. There is a problem in that the sales opportunity loss of a product in a shop, which is obtained based on the number of entries, is not accurate.

This invention has been made in view of the above-mentioned circumstances, and has an object to provide a sales analysis apparatus and the like, which are capable of accurately acquiring a sales opportunity loss of a product in a shop.

### Means to Solve the Problem

In order to achieve the above-mentioned object, a sales analysis apparatus according to a first aspect of this invention comprises:

a movement record acquisition unit configured to analyze image data including an image obtained by photographing an inside of a shop, to thereby acquire a movement record of a person in the shop;

a stay detection unit configured to detect, based on the movement record, a stay location at which the person in the shop has stayed for a predetermined stay period or longer;

a checkout line detection unit configured to detect, based on the movement record, a checkout line region being a region occupied by a person waiting for payment in the shop;

an extraction unit configured to extract, for each person for which the stay location is detected, a product corresponding to the stay location included in a region excluding the checkout line region in the shop, based on arrangement data in which a product and an arrangement location of the product are associated with each other;

a payment statistic acquisition unit configured to acquire, based on the movement record for each person for which the stay location is detected, a passage statistic of a payment region determined in advance as a region in which a customer of the shop is positioned at a time of payment; and

a calculation unit configured to increase, when the extracted product is not purchased based on the passage statistic of the payment region, a sales opportunity loss of the unpurchased product.

A sales analysis method according to a second aspect of this invention comprises:

analyzing image data including an image obtained by photographing an inside of a shop, to thereby acquire a movement record of a person in the shop:

detecting, based on the movement record, a stay location at which the person in the shop has stayed for a predetermined stay period or longer;

detecting, based on the movement record, a checkout line region being a region occupied by a person waiting for payment in the shop;

extracting, for each person for which the stay location is detected, a product corresponding to the stay location included in a region excluding the checkout line region in the shop, based on arrangement data in which a product and an arrangement location of the product are associated with each other:

acquiring, based on the movement record for each person for which the stay location is detected, a passage statistic of a payment region determined in advance as a region in which a customer of the shop is positioned at a time of payment; and

increasing, when the extracted product is not purchased based on the passage statistic of the payment region, a sales opportunity loss of the unpurchased product.

A program recording medium according to a third aspect of this invention has recorded thereon a program for causing a computer to execute;

analyzing image data including an image obtained by photographing an inside of a shop, to thereby acquire a movement record of a person in the shop;

detecting, based on the movement record, a stay location at which the person in the shop has stayed for a predetermined stay period or longer;

detecting, based on the movement record, a checkout line region being a region occupied by a person waiting for payment in the shop;

extracting, for each person for which the stay location is detected, a product corresponding to the stay location included in a region excluding the checkout line region in the shop, based on arrangement data in which a product and an arrangement location of the product are associated with each other:

acquiring, based on the movement record for each person for which the stay location is detected, a passage statistic of a payment region determined in advance as a region in which a customer of the shop is positioned at a time of payment; and

increasing, when the extracted product is not purchased based on the passage statistic of the payment region, a sales opportunity loss of the unpurchased product.

### Effect of the Invention

According to this invention, it is possible to accurately acquire the sales opportunity loss of a product in the shop.

### BRIEF DESCRIPTION OF THE DRAWING

FIG. 1 is a diagram for illustrating an outline of a physical configuration of a sales management system according to a first embodiment of this invention.

FIG. 2 is a plan view for illustrating a positional relationship between shelves and various kinds of regions in a shop in the first embodiment.

FIG. 3 is a diagram for illustrating a functional configuration of a POS management apparatus in the first embodiment.

FIG. 4 is a diagram for illustrating a functional configuration of a security management apparatus in the first embodiment.

FIG. 5 is a diagram for illustrating a functional configuration of a sales analysis apparatus according to the first embodiment.

FIG. 6 is for illustrating examples of data indicating a position of a region set in advance in the first embodiment, in which (a) shows an example of customer service region data and (b) shows an example of payment region data.

FIG. 7 is a table for showing an example of arrangement data in the first embodiment.

FIG. 8 is a flow chart for illustrating an example of sales analysis processing in the first embodiment.

FIG. 9 is a flow chart for illustrating an example of movement record acquisition processing in the first embodiment.

FIG. 10 is a diagram for illustrating an example of small regions obtained by dividing a frame, which is adopted in image analysis processing in the first embodiment.

FIG. 11 is a diagram for schematically illustrating, on the plan view of an inside of the shop, a movement record acquired for one customer.

FIG. 12 is a diagram for schematically illustrating, on the plan view of the inside of the shop, movement records acquired for three customers in the shop at a first time point.

FIG. 13 is a diagram for schematically illustrating, on the plan view of the shop, movement records acquired for three customers in the shop at a second time point, which is after the first time point.

FIG. 14 is a flow chart for illustrating an example of calculation processing in the first embodiment.

FIG. 15 is a diagram for illustrating a functional configuration of a sales analysis apparatus according to a second embodiment of this invention.

FIG. 16 is a flow chart for illustrating an example of sales analysis processing in the second embodiment.

FIG. 17 is a diagram for schematically illustrating, on the plan view of the inside of the shop, a movement record acquired for one clerk.

### MODES FOR EMBODYING THE INVENTION

Now, a description is given of embodiments of this invention with reference to the drawings. In the following description, terms representing forward, backward, upward, downward, leftward, and rightward directions are used for description, and are not to limit this invention.

### First Embodiment

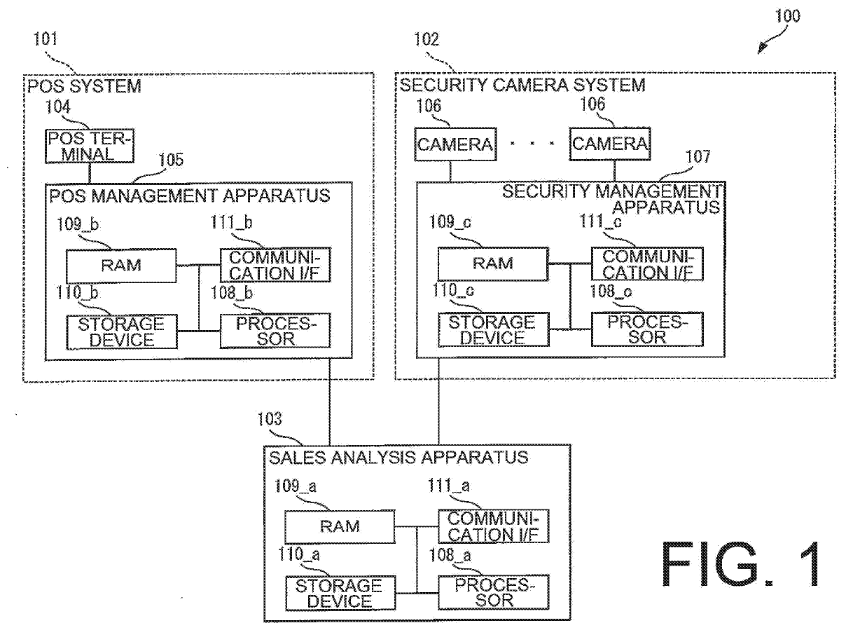

A sales management system 100 according to a first embodiment of this invention is a system for managing sales of products in a shop, and as illustrated in FIG. 1, includes a POS (Point-Of-Sales) management system 101, a security camera system 102, and a sales analysis apparatus 103.

<Outline of Configuration of Sales Management System>

As illustrated in FIG. 1, the sales management system 100 includes the POS system 101, the security camera system 102, and the sales analysis apparatus 103 as physical components. Each of the POS system 101 and the security camera system 102 is communicably connected to the sales analysis apparatus 103. The connection method is a network such as a wired network, a wireless network, or a LAN (local area network) combining the wired network and the wireless network.

The POS system 101 is a system for aggregating, for example, sales statistics of products in the shop, and includes a POS terminal 104 and a POS management apparatus 105 as physical components. The POS terminal 104 is a POS register machine, and buttons, a barcode reader, and the like for receiving input of data are mounted thereon. In this embodiment, a description is given of an exemplary case in which the POS system 101 includes one POS terminal 104. However, the POS system 101 may include a plurality of POS terminals 104.

The security camera system 102 is a monitoring system for preventing a crime in a shop, and includes a plurality of cameras 106 and a security management apparatus 107 as physical components. Each of the plurality of cameras 106 continuously photographs a region determined in advance in the shop, and outputs photography data including the photographed moving image.

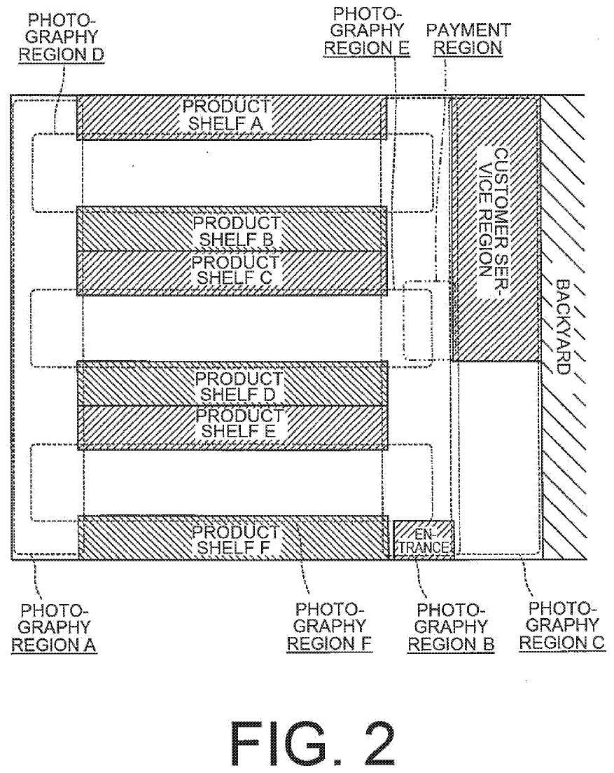

The shop is a convenience store or a supermarket, for example. In this embodiment, as illustrated in FIG. 2, which is a diagram of an inside of the shop as viewed from the above, product shelves A to F, an aisle, a customer service region, and a backyard are set in the shop. A payment region is described later.

Specifically, the product shelves A to F are arranged in order from a far left side of the shop from the viewpoint of a person entering an entrance of the shop. The aisles in the shop, through which persons such as a customer and a clerk pass, are set between the product shelves A and B, between the product shelves C and D, between the product shelves E and F, and on the left and right sides of the product shelves A to F.

Further, the customer service region is set on a far right side of the shop from the viewpoint of a person entering the entrance. The customer service region is a region for a clerk to serve a customer, and is appropriately set in the shop. When the shop is a convenience store, the customer service region is typically enclosed by a counter, and a POS terminal having a register function is installed on that counter. The customer service region is basically a region that only the clerk, who is a person concerned in the shop, is allowed to enter.

The backyard is set over an entire region on a near to far right side of the customer service region from the viewpoint of a person entering the entrance. The backyard is used as, for example, a warehouse of products or a staff room for clerks. Similarly to the customer service region, the backyard is also basically a region that only the clerk is allowed to enter.

Further, the plurality of cameras 106 photograph each aisle in the shop, a part of the product shelves A to F, and the customer service region. Specifically, in this embodiment, the six cameras 106 are installed, and each of the six cameras 106 is set so as to photograph a corresponding one of photography regions A to F. Adjacent photography regions may partially overlap with each other among the plurality of photography regions. However, the plurality of photography regions are basically different from each other.

The sales analysis apparatus 103, the POS management apparatus 105, and the security management apparatus 107 include, for example, processors 108_a to 108c, RAMs (random access memories) 109_a to 109_c, storage devices 110_a to 110_c, and communication I/Fs (interfaces) 111_a to 111_c, respectively, as physical components.

The processors 108_a to 108_c are respective pieces of hardware for executing software programs stored in the apparatus 103, 105, and 107, and each include an arithmetic processing device, a register, and a peripheral circuit, for example. The POS management apparatus 105, the security management apparatus 107, and the sales analysis apparatus 103 may each include the plurality of processors 108_a to 108_c.

The RAMs 109_a to 109_c are memories to be used as respective work areas of the processors 108_a to 108_c. The storage devices 110_a to 110_c each include a SSD (solid state drive) and a HDD (hard disc drive), for example. The communication I/Fs 111_a to 111_c may each be used for any one or both of wired communication and wireless communication.

<Functional Configuration of Each of Apparatus 103, 105, and 107>

Each of the POS management apparatus 105, the security management apparatus 107, and the sales analysis apparatus 103 implements a function described below by executing an installed program, for example.

The function included in each of the POS management apparatus 105, the security management apparatus 107, and the sales analysis apparatus 103 is not limited to the function described below, and other functions may appropriately be added to each apparatus. Further, a part or all of the functions implemented by the sales analysis apparatus 103 may be incorporated into apparatus constructing one or both of the security camera system 102 and the POS system 101. In such a case, the sales analysis apparatus 103 is constructed together with an apparatus incorporating a part of the functions, or is included in an apparatus incorporating all the functions.

(POS Management Apparatus 105)

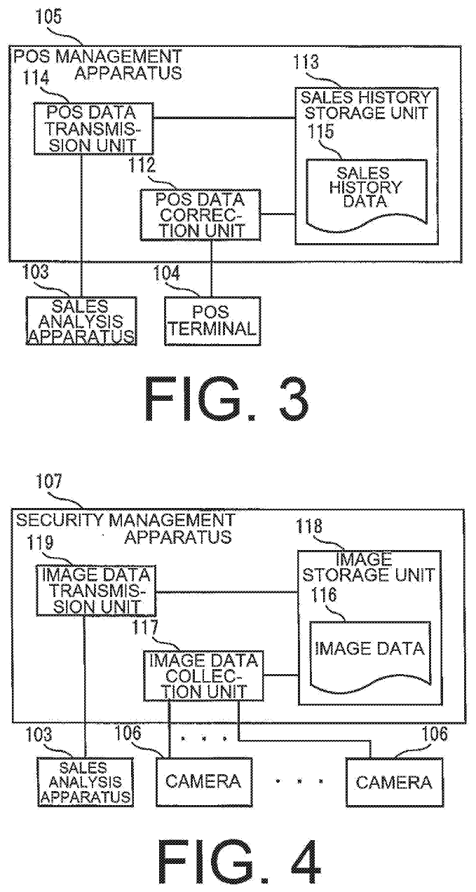

The POS management apparatus 105 is an apparatus configured to collect and hold data received from the POS terminal 104, and as illustrated in FIG. 3, the POS management apparatus 105 includes a POS data collection unit 112, a sales history storage unit 113, and a POS data transmission unit 114 from the functional point of view.

The POS data collection unit 112 is configured to receive, from the POS terminal, POS data including, for example, a stock quantity or sales history of a product in the shop. When the POS data collection unit 112 has received the POS data, the POS data collection unit 112 causes the sales history storage unit 113 to store the sales history data 115 included in the POS data.

The sales history storage unit 113 is configured to hold the sales history data 115. The sales history data 115 is data indicating the sales history of a product in the shop, and is data in which, for example, a sold product, a sales quantity, and a sales date and time are associated with one another for each customer.

When the POS data transmission unit 114 has received a request from the sales analysis apparatus 103, the POS data transmission unit 114 reads out the sales history data 115 relating to the request from the sales history storage unit 113, and transmits the sales history data 115 to the sales analysis apparatus 103.

(Security Management Apparatus 107)

The security management apparatus 107 is an apparatus for managing image data 116 including an image photographed by each of the plurality of cameras 106, and as illustrated in FIG. 4, the security management apparatus 107 includes an image data collection unit 117, an image storage unit 118, and an image data transmission unit 119 from the functional point of view.

The image data collection unit 117 is configured to receive the image data 116 from each of the plurality of cameras 106. When the image data collection unit 117 has received the image data 116, the image data collection unit 117 causes the image storage unit 118 to store the image data 116.

The image storage unit 118 is configured to hold the image data 116. The image data 116 includes a moving image of the inside of the shop, which is continuously photographed by each of the plurality of cameras 106 while the shop is open, for example.

When the image data transmission unit 119 has received a request from the sales analysis apparatus 103, the image data transmission unit 119 reads out the image data 116 relating to the request from the image storage unit 118, and transmits the image data 116 to the sales analysis apparatus 103.

(Sales Analysis Apparatus 103)

The sales analysis apparatus 103 is an apparatus configured to calculate the sales opportunity loss of a product in the shop. The sales analysis apparatus 103 calculates the sales opportunity loss of a product based on a movement record of a customer obtained by analysis of the image data 116 and a sales history of the product obtained from the sales history data 115.

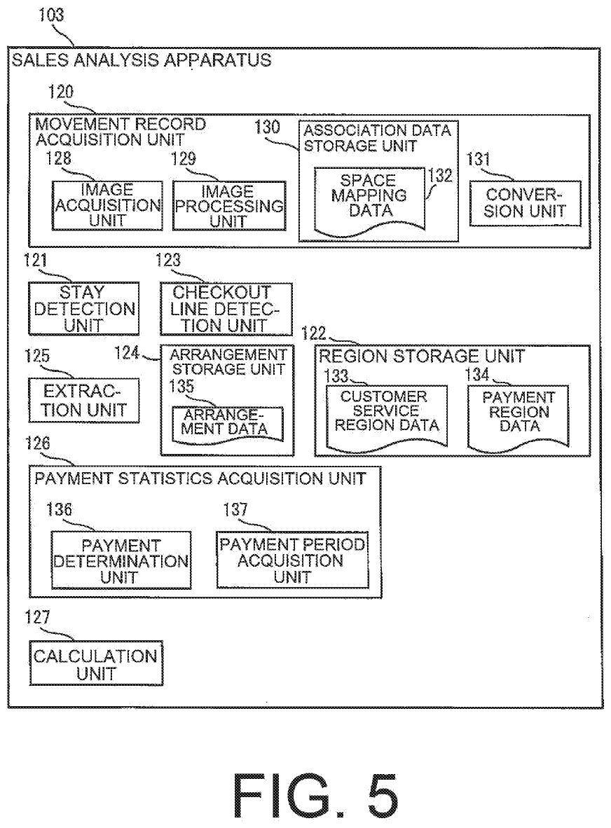

As illustrated in FIG. 5, the sales analysis apparatus 103 includes a movement record acquisition unit 120, a stay detection unit 121, a region storage unit 122, a checkout line detection unit 123, an arrangement storage unit 124, an extraction unit 125, a payment statistic acquisition unit 126, and a calculation unit 127.

The movement record acquisition unit 120 is configured to analyze the image data 116 transmitted from the image data transmission unit 119, to thereby acquire the movement record of a person in the shop.

The movement record is information obtained by measuring, for each person in the shop at a predetermined time interval (e.g., frame rate), a path through which the person has moved since the person entered the shop until that person has got out of the shop.

Specifically, for example, the movement record includes, for each person in the shop, a position of the person in the shop and a date and time associated with the position. The position is represented in, for example, a two-dimensional orthogonal coordinate system with a bottom left corner serving as an origin on the plan view of the inside of the shop illustrated in FIG. 2. The date and time are represented by, for example, “year/month/day” and “hour/minute/second”.

Specifically, the movement record acquisition unit 120 includes an image acquisition unit 128, an image processing unit 129, an association data storage unit 130, and a conversion unit 131.

The image acquisition unit 128 is configured to acquire the image data 116 transmitted from the image data transmission unit 119.

The image processing unit 129 is configured to acquire where and when a person in the shop has passed in the image by analyzing the image data 116.

The association data storage unit 130 stores space mapping data 132. The space mapping data 132 is data for mapping a position in the image to a position in a real space.

The conversion unit 131 is configured to acquire where and when a person in the shop has passed in the real space based on the space mapping data 132 stored in the association data storage unit 130 and a result acquired by the image processing unit 129.

The stay detection unit 121 is configured to acquire a stay location of a person in the shop based on the movement record acquired by the movement record acquisition unit 120. The stay location is a location at which a person in the shop has stayed for a stay period or longer. The stay period is a period appropriately determined in advance, and for example, a minimum period or average period in which a customer stops by at a product shelf to purchase a product may be set as the stay period.

The region storage unit 122 stores data indicating a position of a region set in advance. Specifically, the region storage unit 122 stores customer service region data 133 and payment region data 134.

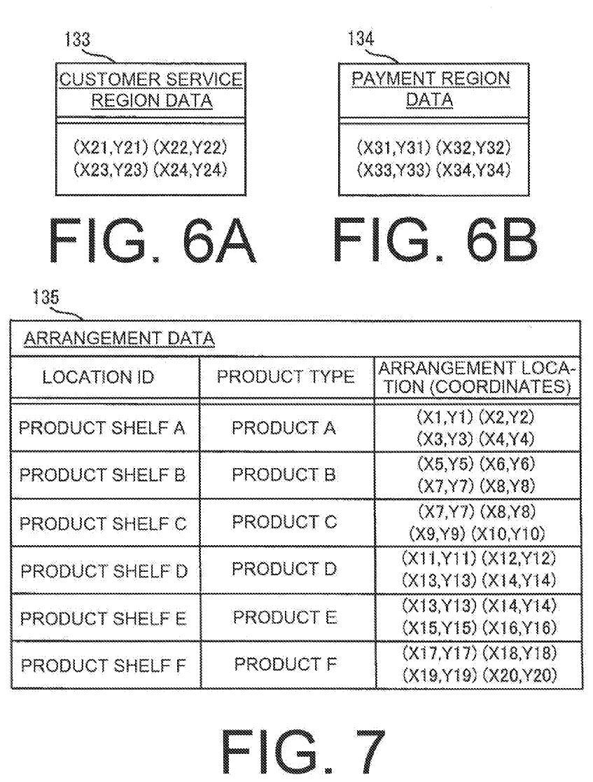

The customer service region data 133 is data indicating a position of the above-mentioned customer service region. The position of the customer service region may be represented by coordinate values in the real space as exemplified in FIG. 6(a). The customer service region data 133 exemplified in FIG. 6(a) contains coordinate values of each of four corners of the customer service region in the real space in association with the customer service region having approximately a rectangular shape as illustrated in FIG. 2.

The payment region data 134 is data indicating the position of the payment region. The payment region is a region determined in advance as a region in which a customer of the shop is positioned at the time of payment, and is determined in association with the position of the register. The position, shape, size, or the like of the payment region may be appropriately determined, but it is assumed in this embodiment that a region having approximately a square shape is set as illustrated in FIG. 2, for example.

In the payment region data 134, the position of the payment region may be represented by coordinate values in the real space as exemplified in FIG. 6(b). The payment region data 134 exemplified in FIG. 6(b) contains coordinate values of each of four corners of the payment region in the real space in association with the payment region having approximately a square shape as illustrated in FIG. 2.

The checkout line detection unit 123 is configured to detect a checkout line region based on the movement record acquired by the movement record acquisition unit 120. The checkout line region is a region occupied by a person waiting for payment in the shop.

The arrangement storage unit 124 stores arrangement data 135. The arrangement data 135 is data indicating a location at which each product in the shop is arranged. In the arrangement data 135, information indicating a product and information indicating the location at which the product is arranged are associated with each other.

The extraction unit 125 is configured to extract, based on the arrangement data 135 for each person detected at stay location, a product corresponding to the stay location included in a region other than the checkout line region in the shop.

The payment statistic acquisition unit 126 is configured to acquire, for each person whose stay location is detected, a passage statistic of the payment region based on the movement record. The passage statistic of the payment region includes whether a person has passed through the payment region, or a time when the person has passed through the payment region.

Specifically, the payment statistic acquisition unit 126 includes a payment determination unit 136 and a payment period acquisition unit 137.

The payment determination unit 136 is configured to determine, as the passage statistic of a register, whether each person whose stay location is detected has settled the payment based on the movement record.

When the payment determination unit 136 has determined that payment is complete, the payment period acquisition unit 137 acquires a payment period, which is a period of payment, based on the movement record.

When the product extracted by the extraction unit 125 is not purchased, the calculation unit 127 increases the sales opportunity loss of the unpurchased product. The calculation unit 127 refers to at least the passage statistic of the payment region acquired by the payment statistic acquisition unit 126 in order to calculate the sales opportunity loss.

Specifically, when the payment determination unit 136 has determined that payment is not complete, the calculation unit 127 increases the sales opportunity loss of the product extracted by the extraction unit 125 for the person who is a target of determination.

Further, when the payment determination unit 136 has determined that payment is complete, the calculation unit 127 acquires the sales history data 115 from the POS data transmission unit 114, and refers to the acquired sales history data 115. Then, when there is a product unpurchased within a predetermined period among the products extracted by the extraction unit 125, the calculation unit 127 increases the sales opportunity loss of the unpurchased product.

The phrase “predetermined period” refers to a period that depends on the payment period acquired by the payment period acquisition unit 137. As a specific example, the phrase “predetermined period” may refer to the payment period acquired by the payment period acquisition unit 137, or may refer to a temporal range determined in advance with the payment period serving as a reference.

This concludes the description of the configuration of the sales management system 100 according to the first embodiment of this invention. Now, a description is given of an operation of the sales management system 100 according to the first embodiment.

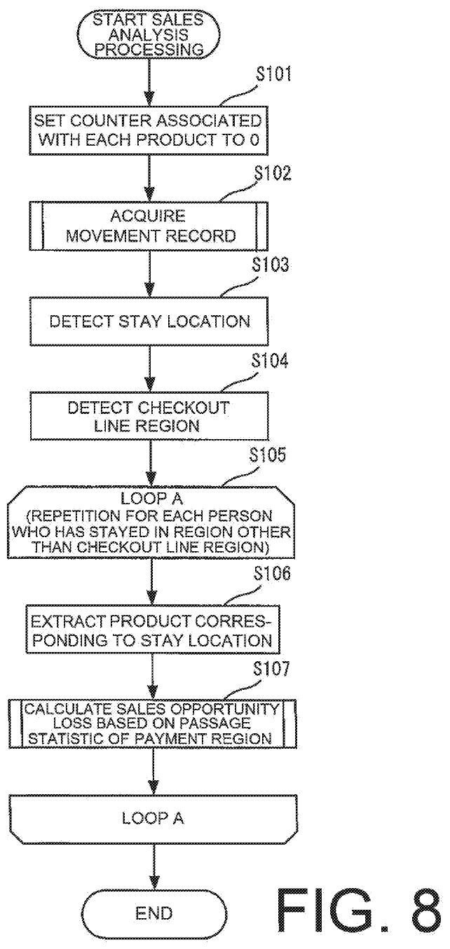

The sales analysis apparatus 103 of the sales management system 100, which is characteristic of this invention, is configured to execute sales analysis processing as illustrated in a flow chart of FIG. 8. The sales analysis processing is processing of calculating the sales opportunity loss of a product in the shop. The sales analysis processing may be executed in a period determined in advance once a month, for example, or when the sales analysis apparatus 103 has received an instruction from the user, the sales analysis processing may be executed in accordance with the instruction.

The instruction from the user is given to the sales analysis apparatus 103 via an input unit constructed by, for example, a button or a touch panel (not shown).

The calculation unit 127 sets a counter associated with each product to “0” (Step S101).

This counter is used for calculating the sales opportunity loss of each product.

The movement record acquisition unit 120 acquires the image data 116 from the security management apparatus 107, and analyzes the image data 116, to thereby acquire the movement record of a person in the shop (Step S102).

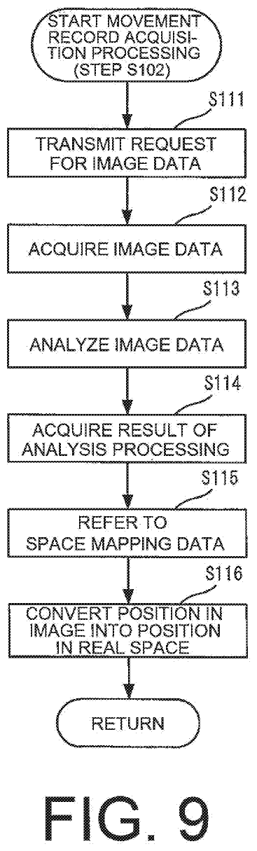

Specifically, in the movement record acquisition processing (Step S102), as illustrated in a flow chart of FIG. 9, the image acquisition unit 128 requests the security management apparatus 107 to transmit the image data 116 (Step S111). The image acquisition unit 128 acquires the image data 116 transmitted from the image data transmission unit 119 in response to this request (Step S112).

The image processing unit 129 analyzes the image data 116 (Step S113). With this, the image processing unit 129 acquires where and when a person in the shop has passed in the image.

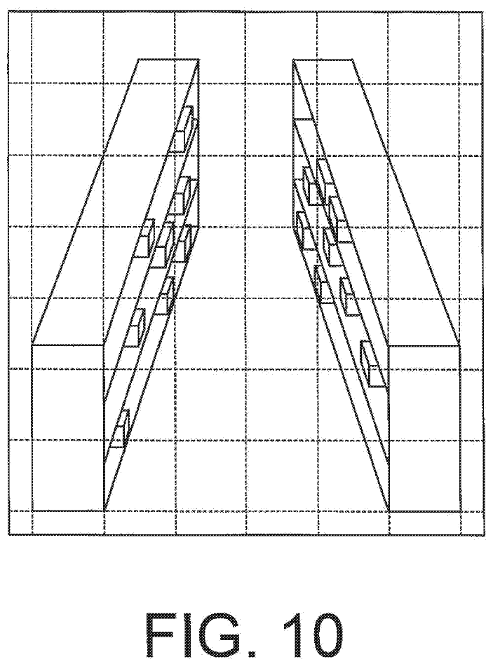

More specifically, the image processing unit 129 identifies a person in each of frames forming a moving image included in the image data 116. The image processing unit 129 uses a plurality of small regions, which are obtained by dividing a frame into blocks having a predetermined size as exemplified in FIG. 10, to identify in which of the plurality of small regions the person is included. In this manner, through analysis of the image data 116, the image processing unit 129 acquires when and which of the plurality of small regions obtained by dividing the frame a person in the shop has passed through.

In this embodiment, a description has been given of an example of dividing the frame into a plurality of small block regions. However, the shape and size of the plurality of small regions may appropriately be set.

The conversion unit 131 acquires (Step S114) the result of analysis processing (Step S113).

The result of analysis processing (Step S113) is information indicating the position of a person in the image, and for example, is information for identifying a small region occupied by a person, for example.

The conversion unit 131 refers to the space mapping data 132 stored in the association data storage unit 130 (Step S115).

In this embodiment, as described above, image processing is executed by dividing the frame into small regions. In response to this, a position in the image and a position in the real space may be associated with each other by associating each of the plurality of small regions obtained by dividing the frame with the real space in the shop. Thus, in the space mapping data 132, for example, information for identifying each of four corners of the plurality of small regions and information indicating a position in the shop may be associated with each other. The information indicating a position in the shop is represented by coordinate values in the above-mentioned coordinate system corresponding to the real space in the shop, for example.

The conversion unit 131 converts a position in the image of a person in the shop into a position in the real space based on the result of analysis processing acquired in Step S114 and the space mapping data 132 referred to in Step S115 (Step S116).

Specifically, on the basis of the result of analysis processing and the space mapping data 132, the conversion unit 131 converts information identifying a small region occupied by a person in the image into information indicating coordinate values in the above-mentioned coordinate system corresponding to the inside of the shop. The “coordinate values in the coordinate system corresponding to the inside of the shop” are an example of the position in the real space. When a person occupies a part of the small region in the image, the part of the small region occupied by the person in the image may be converted into a position in the shop through proportional distribution, for example.

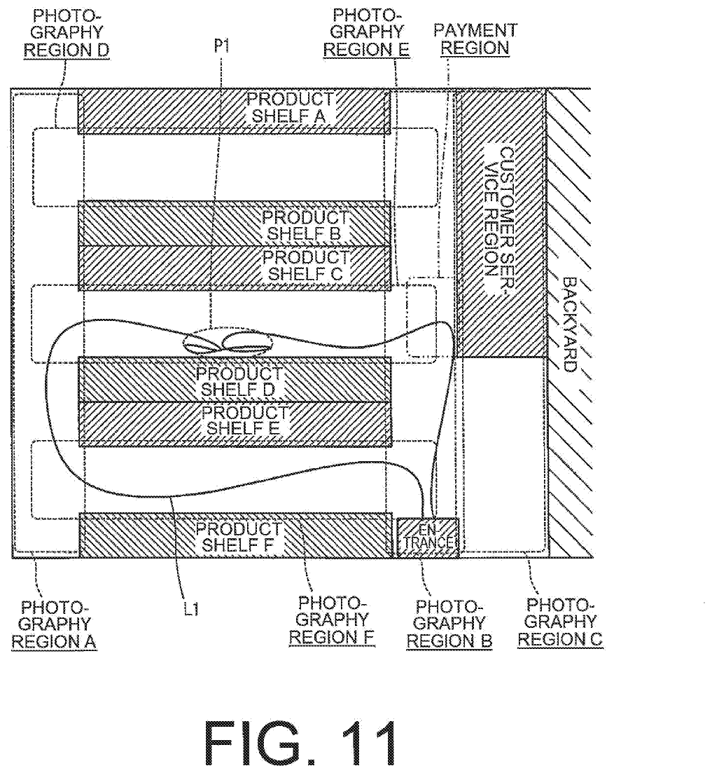

The conversion unit 131 executes Step S116 in this manner to acquire where and when a person in the shop has passed in the real space. FIG. 11 is a schematic diagram obtained by mapping, on a diagram of the inside of the shop as viewed from the above, a line (movement curve) L1 smoothly connecting between movement records acquired through the execution of the processing of Step S116.

Referring back to FIG. 8, the stay detection unit 121 acquires a stay location of a person in the shop based on the movement record acquired in Step S102 (Step S103).

In the example illustrated in FIG. 11, the movement range of this customer is located within a range determined in advance in front of a product shelf D. When the customer has stayed in the movement range in front of the product shelf D for a stay period or longer, this movement range is detected as a stay location P1.

The checkout line detection unit 123 detects a checkout line region based on the movement record acquired in Step S102 (Step S104).

Specifically, the checkout line region is detected by comparing the movement records of a person in the shop at two different time points.

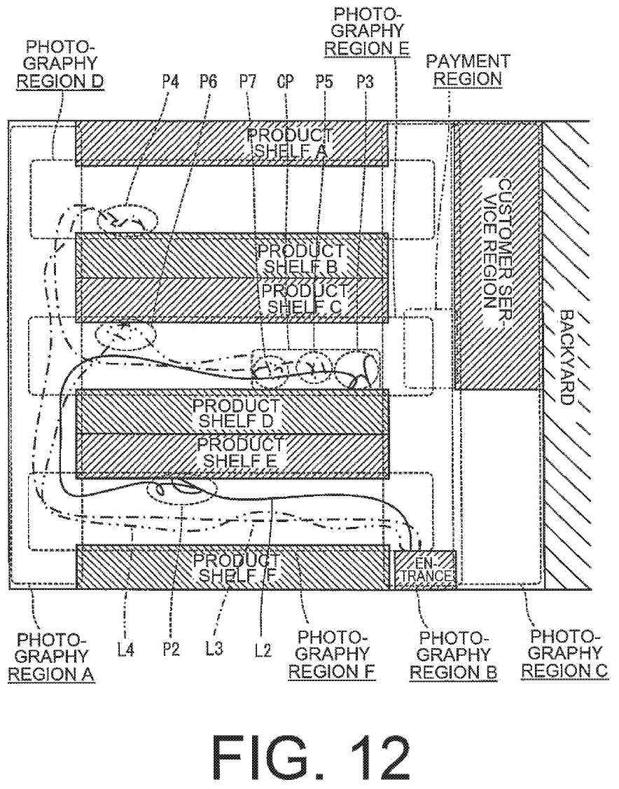

First, at a first time point, as illustrated in FIG. 12, when there is a region including a plurality of stay locations close to one another by a predetermined determination distance D or less, this region is detected as a candidate region CP. The candidate region CP means a region being a candidate of the checkout line region.

FIG. 12 is a schematic diagram obtained by mapping, on the diagram of the inside of the shop as viewed from the above similarly to FIG. 11, a movement record of a person in the shop at the first time point. FIG. 12 is an illustration of an example in which there are three customers A to C in the shop, and includes lines L2 to L4 (movement curves) smoothly connecting between movement records of the respective customers A to C.

For example, a movement curve L2 indicated by the solid line corresponds to the movement record of the customer A. A movement curve L3 indicated by the one-dot chain line corresponds to the movement record of the customer B. A movement curve L4 indicated by the two-dot chain line corresponds to the movement record of the customer C.

As can be understood with reference to FIG. 12, the customer A enters the shop, passes through a stay location P2 in front of a product shelf E, and then stays at a stay location P3 at the first time point. The customer B enters the shop, passes through a stay location P4 in front of a product shelf B, and then stays at a stay location P5 at the first time point. The customer C enters the shop, passes through a stay location P6 in front of a product shelf C. and then stays at a stay location P7 at the first time point.

Meanwhile, a distance between the stay location P3 and the stay location P5 is smaller than the determination distance D. A distance between the stay location P5 and the stay location P7 is smaller than the determination distance D. Thus, a region including the stay location P3, the stay location P5, and the stay location P7 is detected as the candidate region CP.

In this embodiment, the stay location is detected as a movement range having a width. However, the distance between different stay locations in this case may be a shortest distance between outer edges of stay locations, or may be a distance between centers of stay locations.

Next, when, among persons in the candidate region, at least one person is detected in the payment region, and the remaining persons keeps staying in the candidate region at a second time point, the candidate region is detected as the checkout line region.

In this case, the second time point is a time point after the first time point. For example, the second time point may be set as a time point after elapse of a predetermined period of time since the first time point. Further, the “predetermined period of time” may be set with reference to, for example, an average period of time required for payment at the shop, a minimum or maximum period of time required for payment at the shop, or a period of time between the minimum period and the maximum period required for payment at the shop. As a specific example, one or a plurality of periods from among 15 seconds, 30 seconds, 40 seconds, 45 seconds, 60 seconds, and 90 seconds may be adopted as the “predetermined period of time”.

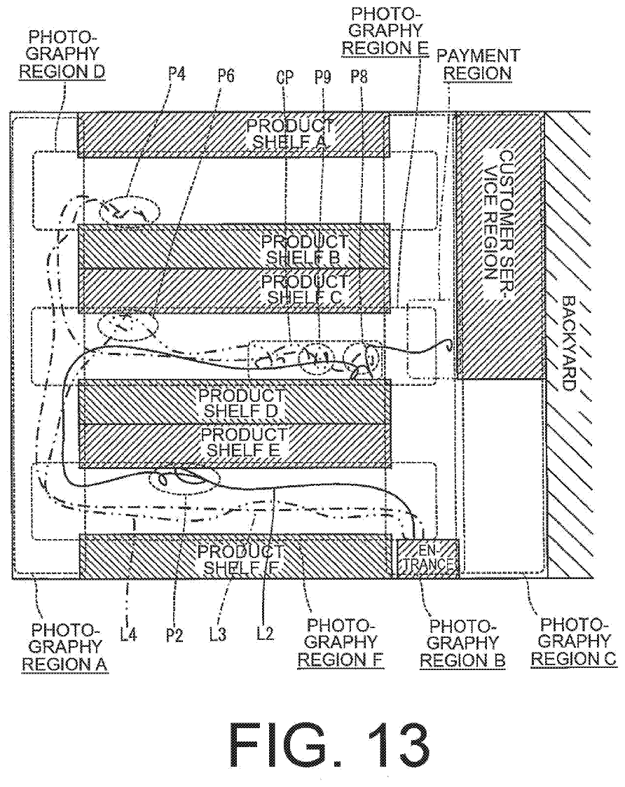

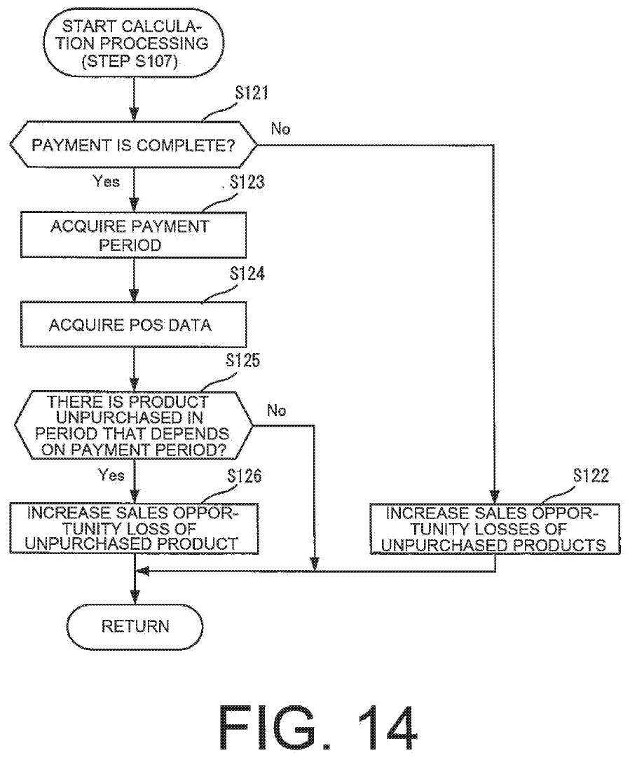

FIG. 13 is a diagram obtained by mapping, on the diagram of the inside of the shop as viewed from the above similarly to FIG. 11, a movement record of a person in the shop at the second time point. In FIG. 13, the stay locations P3, P5, and P7 are not shown to facilitate understanding of description.

As illustrated in FIG. 13, at the second time point, the customer A is detected in the payment region. Further, the customers B and C are detected to stay at the stay locations P8 and P9, respectively, and the stay locations P8 and P9 are both included in the candidate region CP. Thus, the candidate region CP detected at the first time point is detected as the checkout line region at the first time point.

When the stay locations P8 and P9 overlap with the candidate region CP by predetermined proportions or more, respectively, the stay locations P8 and P9 may be determined to be included in the candidate region CP.

In this manner, when the following conditions (1) and (2) are satisfied, the candidate region is detected as the checkout line region. The condition (1) is a condition that the candidate region is detected at the first time point. The condition (2) is a condition that the stay location of at least one person is detected in the payment region at the second time point among a plurality of persons staying in the stay location included in the candidate region, and the stay locations of remaining persons are detected in the candidate region.

In the shop, Step S106 to Step S108 are repeated for each person who has stayed in a region other than the checkout line region detected in Step S104 (loop A in Step S105).

The extraction unit 125 refers to the arrangement data 135. The extraction unit 125 extracts, based on the arrangement data 135, a product corresponding to a stay location included in a region other than the checkout line region in the shop (Step S106).

When the payment statistic acquisition unit 126 has acquired the passage statistic of the payment region based on the movement record, the calculation unit 127 calculates the sales opportunity loss based on the passage statistic of the payment region (Step S107).

Specifically, in the calculation processing (Step S107), as illustrated in FIG. 14, the payment determination unit 136 determines whether a person who is a target of processing in the loop A (Step S105) has settled the payment based on the movement record (Step S121).

The determination in Step S121 may be performed in accordance with a period of time in which the person who is the target of processing has stayed in the payment region, for example.

More specifically, for example, when the person has stayed in the payment region for a longer period of time than the minimum period required for payment within a period since the person has entered the shop until the person has got out of the shop, that person may be determined to have settled the payment. Alternatively, when the person has not entered the payment region within the period since the person has entered the shop until the person has got out of the shop, that person may be determined not to have settled the payment. Alternatively, when the person has entered the payment region but has passed through the payment region without exceeding the minimum period required for payment within the period since the person has entered the shop until the person has got out of the shop, that person may be determined not to have settled the payment. The phrase “minimum period required for payment” is only an example of a period serving as a criterion for determining whether payment is complete, and may be set appropriately.

When payment is determined not to be complete (No in Step S121), all the products extracted in Step S106 are not purchased, and thus the calculation unit 127 increases the sales opportunity losses of the unpurchased products (Step S122).

The processing in Step S121 is performed for each person whose stay location is detected. Thus, when payment is determined not to be complete, the person who is the target of determination has not purchased a product arranged in a product shelf although the person has stopped by at the product shelf.

In Step S122, in such a case, the sales opportunity loss of the unpurchased product is increased. More specifically, 1 is added to a counter associated with the product. When there are plurality of products extracted in Step S106, 1 is added to the counter associated with each of the products.

When payment is determined to be complete (Yes in Step S121), the payment period acquisition unit 137 acquires a payment period being a period of the payment based on the movement record (Step S123).

Specifically, the payment period acquisition unit 137 identifies, based on the movement record, a period of time in which the person who is the target of processing has stayed in the payment region, to thereby acquire the identified period as the payment period. The payment period includes, for example, a date and time (year/month/day and time point) at which the person who is the target of processing has entered the payment region, and a date and time at which the person has got out of the payment region.

The calculation unit 127 transmits a request for the sales history data 115 to the POS management apparatus 105, and acquires the sales history data 115 from the POS data transmission unit 114 (Step S124).

The calculation unit 127 determines whether there is a product that has not been purchased in a period that corresponds to the payment period among the products extracted in Step S106 (Step S125). In Step S125, the calculation unit 127 performs determination based on the payment period acquired in Step S123 and the sales history data 115 acquired in Step S124.

Specifically, the calculation unit 127 refers to the sales history data 115 acquired in Step S124 to determine whether all the products extracted in Step S106 have been purchased in the payment period acquired in Step S123. When there is at least one unpurchased product among the products extracted in Step S106, the calculation unit 127 determines that there is an unpurchased product. When all the products extracted in Step S106 have been purchased, the calculation unit 127 determines that there is no unpurchased product.

In this case, there may be a deviation due to an error between a time point of determination based on the movement record and a time point of registration into the sales history data 115. Instead of the payment period acquired in Step S123, it may be determined whether the products extracted in Step S106 have been purchased in the payment period extended by a predetermined amount. That is, it may be determined whether the products extracted in Step S106 have been purchased in a period that depends on the payment period acquired in Step S123. In this manner, the “period that depends on the payment period” includes not only the payment period but also the payment period extended by a predetermined amount, for example.

When the calculation unit 127 has determined that there is no unpurchased product (No in Step S125), the calculation unit 127 finishes the calculation processing (Step S109), and returns to the sales analysis processing illustrated in FIG. 8.

When the calculation unit 127 has determined that there is an unpurchased product (Yes in Step S125), the calculation unit 127 increases the sales opportunity loss of the unpurchased product (Step S126).

The person who is the target of processing in Step S125 is a person who has settled the payment after detection of his or her stay location. Thus, the person is likely to have purchased some product. However, it is unclear whether the person who is the target of processing has purchased all the products associated with the stay location detected in Step S103. When there is at least one product among all the products associated with the stay location detected in Step S103, the sales opportunity loss of that product occurs. In Step S126, in such a case, the sales opportunity loss of the unpurchased product is increased.

Specifically, the calculation unit 127 identifies, based on the sales history data 115, the unpurchased product among the products extracted in Step S106 for a person who is the target of processing in the payment period of the person who is the target of processing. Then, the calculation unit 127 adds 1 to the counter associated with the identified product. In this case, when a plurality of unpurchased products are identified among the products extracted in Step S106 for the person who is the target of processing, the calculation unit 127 adds 1 to the counter associated with each of the plurality of identified unpurchased products.

When the sales analysis apparatus 103 has executed the processing of Step S106 and Step S107 for all the persons who have stayed in a region other than the checkout line region, the sales analysis apparatus 103 finishes the processing of the loop A (Step S105), and finishes the sales analysis processing.

This concludes the description of the sales management system 100 according to the first embodiment of this invention.

According to this embodiment, the sales analysis apparatus 103 includes the checkout line detection unit 123 for detecting the checkout line region. Further, the extraction unit 125 extracts, for each person whose stay location is detected, a product corresponding to the stay location included in a region other than the checkout line region. The calculation unit 127 calculates the sales opportunity loss of an unpurchased product among the extracted products based on the passage statistic of the payment region acquired by the payment statistic acquisition unit 126.

In this manner, it is possible to calculate the sales opportunity loss in consideration of stay for the checkout line. Thus, it is possible to accurately acquire the sales opportunity loss of a product in the shop.

According to this embodiment, the payment determination unit 136 acquires, as the passage statistic of the payment region, whether each person whose stay location is detected has settled the payment. As described in this embodiment, a person who has not settled the payment has not purchased all the products extracted by the extraction unit 125 for the person. That is, the sales opportunity losses occur for all the products extracted by the extraction unit 125 for a person who has not settled the payment.

Whether each person whose stay location is detected has settled the payment can be acquired based on the movement record. Thus, it is not required to refer to, for example, the sales history data 115, which means that processing is simplified. Therefore, it is possible to acquire the sales opportunity loss of a product easily and accurately.

According to this embodiment, when the payment determination unit 136 has determined that payment is complete, the payment period acquisition unit 137 acquires the payment period based on the movement record for each person who is the target of determination. Further, when there is a product that is not purchased in a period that depends on the payment period among the products extracted by the extraction unit 125 with reference to the sales history data 115, the calculation unit 127 increases the sales opportunity loss of the unpurchased product.

In this manner, it is possible to acquire the sales opportunity loss of a product by acquiring the payment period, referring to the sales history data 115, and comparing a product associated with a stay location of a customer who has settled the payment with a product actually bought by the customer. In this manner, the sales opportunity loss of a product associated with a customer who has settled the payment can be acquired, and thus it is possible to acquire the sales opportunity loss of a product in the shop more accurately.

According to this embodiment, the checkout line region can be detected by comparing the movement records of a person in the shop at the first time point and the second time point. That is, the checkout line region can be detected based on the movement record. In this manner, it is possible to easily detect the checkout line region, and acquire the sales opportunity loss accurately in consideration of the detected checkout line region. Therefore, it is possible to acquire the sales opportunity loss of a product easily and accurately.

### Second Embodiment

A person who moves inside the shop is not limited to the customer, and includes a clerk. However, in the first embodiment, the sales opportunity loss is acquired without distinguishing between the customer and the clerk. In this embodiment, a description is given of a case in which a clerk is determined automatically, and the sales opportunity loss is acquired based on the movement record in the shop of a person excluding the clerk.

The sales management system according to a second embodiment of this invention may be configured similarly to the sales management system 100 according to the first embodiment in terms of physical components. Each of the POS system 101 and the security camera system 102 may be configured similarly to the first embodiment in terms of function.

The sales management system according to this embodiment and the sales management system 100 according to the first embodiment have different functional configurations of sales analysis apparatus 203 and 103, respectively.

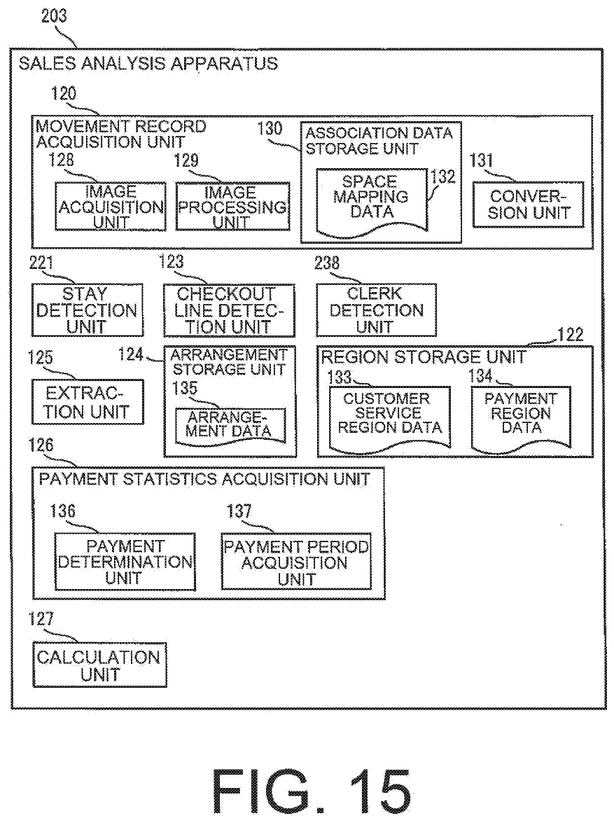

As illustrated in FIG. 15, the sales analysis apparatus 203 according to this embodiment further includes a clerk detection unit 238, and includes a stay detection unit 221 instead of the stay detection unit 121 in the first embodiment.

The sales analysis apparatus 203 according to this embodiment includes functional components similar to those of the sales analysis apparatus 103 according to the first embodiment except for those points. A description of components similar to those of the first embodiment is omitted to simplify the description.

The clerk detection unit 238 is configured to detect a clerk among persons in the shop based on the movement record.

Similarly to the stay detection unit 121 in the first embodiment, the stay detection unit 221 acquires the stay location of a person in the shop based on the movement record acquired by the movement record acquisition unit 120. The stay location detected by the stay detection unit 221 in this embodiment is a location at which a person other than the clerk has stayed for the stay period or longer among persons in the shop.

This concludes the description of the configuration of the sales management system according to the second embodiment of this invention. Now, a description is given of an operation of the sales management system according to this embodiment.

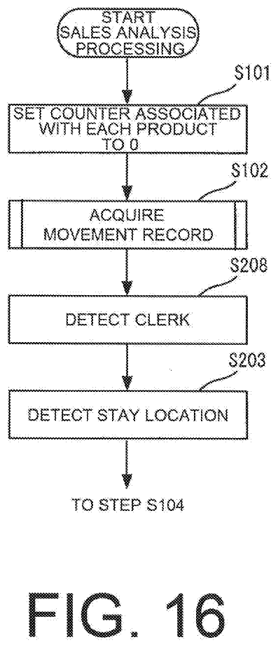

The sales analysis apparatus 203 according to this embodiment is configured to execute sales analysis processing generally similar to that of the first embodiment. In the sales analysis processing in this embodiment, as illustrated in a flow chart of FIG. 16, the sales analysis apparatus 203 executes the processing of Step S101 and Step S102 similar to that of the first embodiment.

After that, the sales analysis apparatus 203 executes clerk detection processing (Step S208), and stay location detection processing (Step S203) instead of the stay location detection processing (Step S103) in the first embodiment. Then, the sales analysis apparatus 203 executes the processing of Step S104 and subsequent processing similar to those of the first embodiment.

In this embodiment, for the sake of simplicity of description, a description is given of clerk detection processing (Step S208) and stay location detection processing (Step S203), which are characteristic of this embodiment, and a description of other processing (Step S111 and Step S102, and Step S104 to Step S107) is omitted.

The clerk detection unit 238 determines, based on the movement record, whether the person in the shop has moved to a predetermined clerk region in the shop, and detects a person who has moved to the predetermined clerk region as a clerk (Step S208).

In the clerk region in this embodiment, a customer service region and a backyard, which only the clerk is allowed to enter, are set. That is, the clerk detection unit 238 in this embodiment detects, as clerks, a person in the customer service region, a person who has entered the customer service region, and a person who has got out of the customer service region among persons in the shop. Further, the clerk detection unit 238 detects, as clerks, a person who has entered the backyard and a person who has got out of the backyard among persons in the shop.

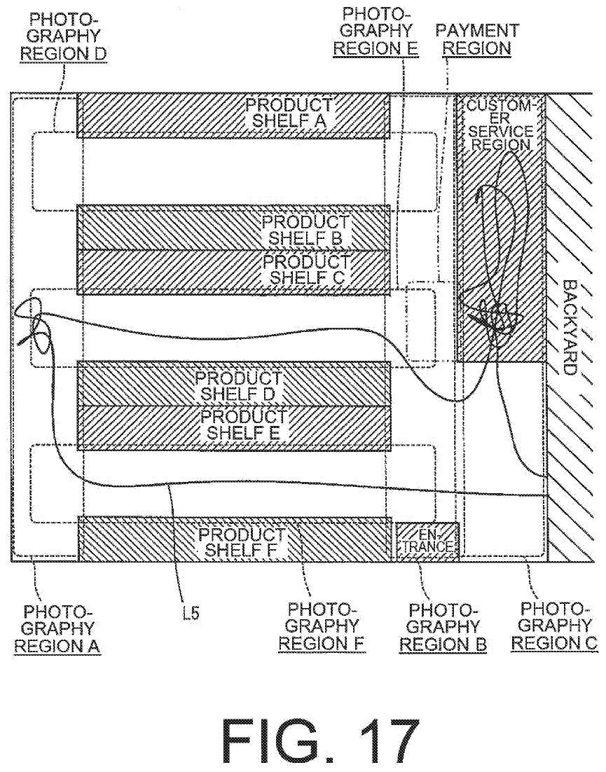

For example, a movement curve L5 illustrated in FIG. 17 contains entry/exit to/from the backyard and stay in the customer service region. It is found that such a movement curve L5 is based on the movement record of a clerk.

The clerk region is not limited thereto, and may be set appropriately.

The stay detection unit 221 detects, based on the movement record, a stay location at which a person excluding the clerk in the shop has stayed for the stay period or longer.

This concludes the description of the sales management system according to the second embodiment of this invention.

According to this embodiment, the following effect is obtained in addition to the effect similar to that of the first embodiment.

According to this embodiment, the sales analysis apparatus 203 includes the clerk detection unit 238. Then, the stay detection unit 221 detects, based on the movement record, the stay location at which a person excluding the clerk in the shop has stayed for the stay period or longer.

Thus, it is possible to detect the stay location of a person excluding the clerk among persons in the shop, to thereby acquire the opportunity loss. Further, it is possible to automatically exclude a clerk from persons in the shop. Therefore, it is possible to acquire the sales opportunity loss of a product in the shop easily and more accurately.

In the above, the embodiments and the modification examples of this invention are described. However, this invention is not limited to those embodiments and modification examples. For example, this invention may include a mode in which the embodiments and the modification examples described above are partially or entirely combined in a suitable manner and a mode suitably changed from the mode of combination.

### INDUSTRIAL APPLICABILITY

This invention can be used for calculating the sales opportunity loss by various kinds of apparatus or systems for managing sales in a shop, for example.

This application is based upon and claims priority from the benefit of priority from Japanese Patent Application No. 2017-243548, filed on Dec. 20, 2017, the disclosure of which is incorporated herein in its entirety by reference.

### REFERENCE SIGNS LIST

100 sales management system
101 POS system
102 security camera system
103, 203 sales analysis apparatus
104 POS terminal
105 POS management apparatus
106 camera
107 security management apparatus
112 POS data collection unit
113 sales history storage unit
114 POS data transmission unit
115 sales history data
116 image data
117 image data collection unit
118 image storage unit
119 image data transmission unit
120 movement record acquisition unit
121, 221 stay detection unit
122 region storage unit
123 checkout line detection unit
124 arrangement storage unit
125 extraction unit
126 payment statistic acquisition unit
127 calculation unit
128 image acquisition unit
129 image processing unit
130 association data storage unit
131 conversion unit
132 space mapping data
133 customer service region data
134 payment region data
135 arrangement data
136 payment determination unit
137 payment period acquisition unit
238 clerk detection unit

1. A sales analysis apparatus, comprising:
a movement record acquisition unit configured to analyze image data including an image obtained by photographing an inside of a shop, to thereby acquire a movement record of a person in the shop;
a stay detection unit configured to detect, based on the movement record, a stay location at which the person in the shop has stayed for a predetermined stay period or longer;
a checkout line detection unit configured to detect, based on the movement record, a checkout line region being a region occupied by a person waiting for payment in the shop;
an extraction unit configured to extract, for each person for which the stay location is detected, a product corresponding to the stay location included in a region excluding the checkout line region in the shop, based on arrangement data in which a product and an arrangement location of the product are associated with each other;
a payment statistic acquisition unit configured to acquire, based on the movement record for each person for which the stay location is detected, a passage statistic of a payment region determined in advance as a region in which a customer of the shop is positioned at a time of payment; and
a calculation unit configured to increase, when the extracted product is not purchased based on the passage statistic of the payment region, a sales opportunity loss of the unpurchased product.

2. The sales analysis apparatus according to claim 1,
wherein the payment statistic acquisition unit includes a payment determination unit configured to determine, as the passage statistic of the payment region, whether each person for which the stay location is detected has settled a payment, based on the movement record, and
wherein the calculation unit is configured to increase, when the person is determined not to have settled the payment, the sales opportunity loss of the product extracted by the extraction unit for the person who is a target of the determination.

3. The sales analysis apparatus according to claim 1,
wherein the payment statistic acquisition unit further includes a payment period acquisition unit configured to acquire, when the person is determined to have settled the payment, a payment period being a period of the payment based on the movement record, and
wherein the calculation unit is configured to refer to sales history data indicating a sales history of a product, and increase, when there is a product unpurchased in a period that depends on the acquired payment period among the products extracted by the extraction unit, the sales opportunity loss of the unpurchased product.

4. The sales analysis apparatus according to claim 1, wherein, when a candidate region including a plurality of stay locations close to one another by a distance smaller than a predetermined determination distance is detected at a first time point, and at least one person is detected in the payment region and remaining persons are detected in the candidate region among a plurality of persons who have stayed in the plurality of stay locations included in the candidate region at a second time point later than the first time point, the checkout line detection unit detects the candidate region as the checkout line region.

5. The sales analysis apparatus according to claim 1, further comprising a clerk detection unit configured to detect a clerk in the shop based on the movement record,
wherein the stay detection unit is configured to detect, based on the movement record, a stay location at which a person excluding the clerk in the shop has stayed for the stay period or longer.

6. The sales analysis apparatus according to claim 1, wherein the clerk detection unit is configured to determine, based on the movement record, whether the person in the shop has moved to a predetermined clerk region in the shop, and detect a person who has moved to the predetermined clerk region as a clerk.

7. The sales analysis apparatus according to claim 1, wherein the movement record acquisition unit includes:
an image processing unit configured to analyze the image data to acquire when and which of a plurality of small regions, which are obtained by dividing a frame into predetermined shapes, the person in the shop has passed through; and
a conversion unit configured to hold in advance space mapping data for mapping each of the plurality of small regions to a position in a real space in the shop, and acquire where and when the person in the shop has passed in the real space based on the space mapping data and a result acquired by the image processing unit.

8. A sales management system, comprising:
the sales analysis apparatus of claim 1;
a security camera system including a plurality of cameras for securing security in the shop; and
a POS system configured to hold sales history data indicating a sales history of a product,
wherein the security camera system is configured to transmit, to the sales analysis apparatus, the image data including the image of the inside of the shop photographed by each of the plurality of cameras, and
wherein the POS system is configured to transmit the held sales history data to the sales analysis apparatus.

9. A sales analysis method, comprising:
analyzing image data including an image obtained by photographing an inside of a shop, to thereby acquire a movement record of a person in the shop;
detecting, based on the movement record, a stay location at which the person in the shop has stayed for a predetermined stay period or longer,
detecting, based on the movement record, a checkout line region being a region occupied by a person waiting for payment in the shop;
extracting, for each person for which the stay location is detected, a product corresponding to the stay location included in a region excluding the checkout line region in the shop, based on arrangement data in which a product and an arrangement location of the product are associated with each other,
acquiring, based on the movement record for each person for which the stay location is detected, a passage statistic of a payment region determined in advance as a region in which a customer of the shop is positioned at a time of payment; and
increasing, when the extracted product is not purchased based on the passage statistic of the payment region, a sales opportunity loss of the unpurchased product.

10. A non-transitory computer readable medium having recorded thereon a program for causing a computer to execute:
analyzing image data including an image obtained by photographing an inside of a shop, to thereby acquire a movement record of a person in the shop;
detecting, based on the movement record, a stay location at which the person in the shop has stayed for a predetermined stay period or longer,
detecting, based on the movement record, a checkout line region being a region occupied by a person waiting for payment in the shop;
extracting, for each person for which the stay location is detected, a product corresponding to the stay location included in a region excluding the checkout line region in the shop, based on arrangement data in which a product and an arrangement location of the product are associated with each other,
acquiring, based on the movement record for each person for which the stay location is detected, a passage statistic of a payment region determined in advance as a region in which a customer of the shop is positioned at a time of payment; and
increasing, when the extracted product is not purchased based on the passage statistic of the payment region, a sales opportunity loss of the unpurchased product.
